(19) United States
(12) Patent Application Publication
(10) Pub. No.: US 2026/0307080 A1
(43) Pub. Date: Oct. 8, 2026

(54) Pipette Tip Support Card Bundles

(71) Applicant: Xcaliber Sciences, Inc., San Diego, CA (US)

(72) Inventors: Arta Motadel, Rancho Santa Fe, CA (US); Pete Blaszcak, Ramona, CA (US); Juan Martin Mendez Padilla, Tijuana (MX)

(21) Appl. No.: 19/708,288

(22) Filed: Jun. 15, 2026

Related U.S. Application Data
(63) Continuation-in-part of application No. 19/394,094, filed on Nov. 19, 2025.
Application No. 19/394,094 is a continuation of application No. 18/620,627, filed on Mar. 28, 2024, now Pat. No. 12,515,227.
(60) Provisional application No. 63/614,919, filed on Dec. 27, 2023.
(60) Provisional application No. 63/567,766, filed on Mar. 20, 2024.

(51) Int. Cl. B01L 9/00

(52) U.S. Cl. CPC B01L 9/543; B01L 2200/025; B01L 2300/045

(57) ABSTRACT

An interleaved pipette tip support card bundle includes two or more support cards with top surfaces facing outwardly and pipette tips extending inwardly to interleave without contact. Receiver slots in each card's underside receive distal ends of opposing tips with clearance, preventing tip-to-tip and tip-to-card contact and reducing static buildup that causes misalignment. Support structures have abutting distal edges that define spacing while permitting full interleaving. Hole arrays are offset for dense packing. Multi-pair bundles with orthogonal orientations form compact assemblies reducing shipping volume by more than 60%. The receiver slots also serve as curing fixtures holding newly molded tips in plumb orientation during post-forming cure, enabling pre-cure packaging and shipping. Lids with cutouts, anti-static materials, and paper or cardboard support structures are disclosed.

### CROSS-REFERENCE TO RELATED APPLICATIONS

This application is a continuation-in-part of U.S. application Ser. No. 19/394,094, filed on Nov. 19, 2025, which claims priority to U.S. application Ser. No. 18/620,627, filed Mar. 28, 2024, which claims priority to U.S. Provisional Application No. 63/614,919 (filed Dec. 26, 2023) and U.S. Provisional Application No. 63/567,766 (filed Mar. 20, 2024), all entitled “Pipette Tip Support Card Bundles.” The entire contents of these applications are incorporated herein by reference.

### FIELD OF THE INVENTION

The invention relates to laboratory consumables, and more particularly to pipette tip support cards (also referred to as trays, decks, or racks) and bundled configurations of such cards for compact shipping, storage, and automated or manual pipette tip loading. The invention further relates to methods of manufacturing pipette tips in which support cards serve an integral fixturing function during post-forming cure.

### BACKGROUND OF THE INVENTION

Disposable pipette tips are essential laboratory consumables routinely supplied in rigid support cards or racks containing an array of holes (commonly 96, 384, or 1536 positions) that hold the tips in a vertical, ready-to-use orientation. To facilitate easy insertion and removal by pipettors, the support holes are typically oversized relative to the proximal mounting portion of the tips. While this oversizing provides manufacturing tolerance and ease of use, it permits lateral movement of the tips within the holes during shipping, handling, and storage. Adjacent tips can rub against one another, generating static electricity that causes the tips to become misaligned or tilted within their respective holes.

Tip misalignment poses significant problems for both manual and, especially, automated pipetting systems. Automated liquid handlers expect each tip to be precisely centered within its support hole so that the pipettor head can reliably engage the proximal mounting portion, form an airtight seal, and aspirate/dispense with accuracy and precision. Static-induced misalignment leads to failed tip pickups, inconsistent sealing, inaccurate volumetric delivery, or complete system errors that interrupt high-throughput workflows and require operator intervention. In high-volume laboratories and core facilities, even low failure rates translate into substantial lost productivity and potential sample waste.

Conventional packaging practice exacerbates these issues. Pipette tip support cards are typically shipped as individual units, either individually wrapped in plastic or placed in separate boxes. When multiple individually packaged cards are consolidated into a larger shipping container, the cards inevitably jostle against one another during transit. This motion increases tip-to-tip contact both within a single card and between adjacent cards, further elevating static charge accumulation and the likelihood of misalignment. The result is a higher incidence of customer complaints, returns, and rework.

Many support cards incorporate full-height aprons or skirts that extend downward from the card periphery to elevate the distal ends of the seated pipette tips above the laboratory benchtop, thereby reducing contamination risk from bench surfaces. Although functionally beneficial for bench use, such tall aprons substantially increase the overall height of each loaded card. When cards are packaged individually, the cumulative shipping volume, freight costs, and packaging material consumption become significant. Moreover, the increased plastic content contributes to laboratory plastic waste streams that many institutions are actively seeking to reduce for environmental and cost reasons.

While various packaging innovations have been introduced to address space and waste concerns—such as stackable rack designs, nested tip configurations within a single rack, and refill systems that allow reuse of outer rack components—these approaches have not fully resolved the core problems of tip-to-tip contact during shipping, static buildup, and resultant misalignment. Stacked or nested systems often still permit relative movement between tips or between tips and rack surfaces, and none provide an integrated solution that simultaneously protects tips in transit, maintains precise alignment for automated pickup, reduces overall package volume, and improves manufacturing efficiency by eliminating secondary curing or straightening operations.

Accordingly, there remains a compelling need for pipette tip support card systems that (i) substantially eliminate tip-to-tip and tip-to-card contact during shipping and handling, thereby minimizing static generation and preserving tip alignment; (ii) maintain precise tip positioning compatible with both manual and automated pipettors; (iii) dramatically reduce shipping and storage volume relative to conventional individually boxed cards; (iv) reduce plastic material usage and associated waste; and (v) integrate with the tip manufacturing process to improve throughput, reduce work-in-process inventory, and enhance final product quality by ensuring tips cure in a true plumb orientation.

### SUMMARY OF THE INVENTION

The present invention provides interleaved pipette tip support card bundles in which pairs of support cards are oriented with their top surfaces facing outwardly and their pipette tips extending inwardly toward one another. The pipette tips from opposing cards interleave in the space between the cards without contacting one another. Distal ends of the pipette tips from one card are received in receiver slots formed in the bottom (underside) surface of the opposing card. The receiver slots are dimensioned to provide clearance around the distal ends so that the tips do not contact the opposing card or bind within the slots. This configuration substantially eliminates tip-to-tip contact and tip-to-card contact during shipping, handling, and storage, thereby greatly reducing static charge buildup and preserving the precise centered alignment of each tip within its support hole.

Each support card includes a support structure extending away from the top surface in the same direction as the pipette tips. The support structure may take the form of a continuous apron wall, a plurality of discrete pillars or legs (preferably at least four pillars positioned at or adjacent the corners of the card), or a paper or cardboard construction. In all cases, the support structure extends a distance less than the extension length of the pipette tips. When two cards are assembled into an interleaved bundle, the distal edges of the opposing support structures abut one another. This abutting contact defines a precise and repeatable spacing between the two top surfaces while permitting the pipette tips to extend past the distal edges into the receiver slots of the opposing card. The resulting bundle height is only slightly greater than the height of a single loaded card plus one tip length, dramatically reducing shipping volume—by more than 60% in typical configurations—compared with conventional individually boxed support cards of equivalent tip count.

The arrays of pipette tip support holes on opposing cards are longitudinally and laterally offset relative to one another. The magnitude and direction of these offsets are selected so that, when the cards are brought together in the interleaved orientation, each pipette tip of one card is coaxially aligned with a corresponding receiver slot in the opposing card. This precise alignment enables dense interleaving without mechanical interference while ensuring that distal ends are captured and laterally stabilized by the receiver slot walls.

Bundles comprising four or six support cards can be formed from two or three interleaved pairs, respectively. The pairs are oriented substantially orthogonally (for example, rotated by about 90°) relative to one another about a central axis of the bundle, resulting in a generally cubic or near-cubic footprint. Such multi-card bundles further enhance shipping and storage density while allowing a user to access pipette tips from any card by simply rotating the bundle to bring the desired top surface into an upward-facing orientation and opening any associated lid. Non-accessed cards remain closed, protecting their tips from contamination or dislodgement.

In certain embodiments, one or more support cards include sliding, snap-fit, or hinged lids configured to cover the top surface and retain the pipette tips securely in their support holes during handling and shipping. Peripheral cutouts or partial holes along at least one edge of the support card define an unobstructed region that permits a multi-channel pipettor to access a subset of tips in a row without mechanical interference from the card edge. The support cards and/or support structures may be formed from anti-static or static-dissipative polymers, or coated with anti-static agents, to further mitigate static accumulation during shipping and use.

A particularly advantageous and previously unrecognized feature of the receiver slots is their utility during the manufacture of pipette tips. After a pipette tip is newly formed—typically by injection molding or an equivalent forming process—the tip may still be warm, soft, dimensionally unstable, or not fully cured, crystallized, or set. In conventional practice, such newly formed tips must be carefully handled, often placed in separate curing fixtures or manually straightened, to prevent them from curing in a bent or out-of-plumb condition. The present support card eliminates these extra steps. A newly formed tip can be immediately inserted into a pipette tip support hole such that its distal end enters and is laterally corralled by the corresponding receiver slot on the underside of the card. Because the receiver slot wall restricts lateral movement of the distal end while the support hole stabilizes the proximal end, the tip is automatically held and maintained in a true plumb (perfectly vertical) orientation as it cools, cures, or dries. No separate curing fixture, manual intervention, or secondary inspection is required.

Moreover, because the loaded support card maintains all tips in the correct plumb geometry, the entire assembly can be packaged and shipped before the pipette tips have reached full cure. Curing or drying continues during transit. This capability shortens the overall manufacturing cycle time, reduces work-in-process inventory, accelerates delivery of finished product to customers, and improves consistency of tip geometry and performance. The same receiver-slot feature that prevents tip-to-tip contact and static buildup during shipping therefore also serves as a built-in, zero-added-cost curing and alignment fixture during manufacture. When the support structure is formed from paper or cardboard, additional environmental benefits are realized: the support structure is recyclable, biodegradable, or compostable, and the overall plastic content of the packaged product is substantially reduced without sacrificing the rigidity needed to support a fully loaded card during normal handling, stacking, and shipping.

The invention therefore simultaneously addresses shipping protection, automated compatibility, volume and waste reduction, manufacturing efficiency, and product quality in a single, elegantly integrated system. Additional aspects, alternatives, and variations will be apparent to persons of ordinary skill in the art in view of the present disclosure. The invention is defined solely by the claims as allowed, and the summary above is provided to introduce certain example embodiments and is not intended to limit the scope of the claims.

### BRIEF DESCRIPTION OF THE DRAWINGS

The invention can be better understood with reference to the following figures. The components in the figures are not necessarily to scale, emphasis instead being placed on clearly illustrating example aspects of the invention. Like reference numerals designate corresponding parts throughout the different views and embodiments. Various features of different disclosed embodiments may be combined to form additional embodiments, which are also part of this disclosure.

FIG. 1A is a top isometric view of an interleaved support card bundle comprised of two pipette tip support cards, with covers partially opened to expose a plurality of pipette tips.

FIG. 1B is a perspective view of a pipette tip support card removed from the bundle illustrating a plurality of peripheral partial holes or cutouts along its edge, configured to prevent interference with a multi-channel pipettor when loading pipette tips.

FIG. 1C is a bottom isometric view of an interleaved support card bundle comprised of two pipette tip support cards.

FIG. 1D is a bottom isometric view of an interleaved support card bundle comprised of two pipette tip support cards, with the aprons removed to illustrate internal structure.

FIG. 1E is a short-side view of an interleaved support card bundle comprised of two pipette tip support cards, with the aprons removed, showing interleaving of the pipette tips.

FIG. 1F is a long-side view of an interleaved support card bundle comprised of two pipette tip support cards, with the aprons removed, showing interleaving of the pipette tips.

FIG. 1G is a long-side view of an interleaved support card bundle comprised of two pipette tip support cards, with the aprons removed, showing interleaving of the pipette tips and a sliding lid in a partially open position.

FIG. 1H is a front view of an interleaved support card bundle comprised of two pipette tip support cards.

FIG. 1I is a front view of separated support cards from an interleaved support card bundle, illustrating the relationship between support structures and pipette tip extension lengths.

FIG. 1J is a top view of two support cards showing longitudinal and lateral offsets between arrays of pipette tip support holes.

FIG. 1K is a top isometric view, with an apron removed, showing pipette tips disposed in underside receiver slots of an opposing card in cross-section.

FIG. 1L is a top isometric view, with an apron removed, showing distal ends of pipette tips from opposing cards disposed in underside receiver slots.

FIG. 2A is a top perspective exploded view of an interleaved support card bundle comprised of four pipette tip support cards arranged as two orthogonally oriented interleaved pairs.

FIG. 2B is a top exploded view of an interleaved support card bundle comprised of four pipette tip support cards.

FIG. 2C is a short-side exploded view of an interleaved support card bundle comprised of four pipette tip support cards.

FIG. 3A is a top isometric exploded view of an interleaved support card bundle comprised of six pipette tip support cards arranged as three orthogonally oriented interleaved pairs.

FIG. 3B is a top exploded view of an interleaved support card bundle comprised of six pipette tip support cards.

The drawings illustrate example embodiments employing apron-style support structures. Equivalent embodiments employing discrete pillars or paper/cardboard support structures are within the scope of the invention and can be implemented by a person of ordinary skill in the art by substituting pillar or paper constructions of appropriate height and rigidity for the illustrated aprons, as further described herein.

### DETAILED DESCRIPTION OF THE INVENTION

Reference is made herein to specific example embodiments of the invention, including presently contemplated best modes for carrying out the invention. These embodiments are illustrated in the accompanying figures. While the invention is described in connection with these specific embodiments, the embodiments are not intended to limit the invention. To the contrary, the embodiments are intended to cover alternatives, modifications, and equivalents as may be included within the spirit and scope of the invention as defined by the appended claims. In the following description, numerous specific details are set forth to provide a thorough understanding of example embodiments. Embodiments of the invention may be implemented without some or all of these specific details. In other instances, process operations well known to persons of ordinary skill in the art are not described in detail so as not to obscure unnecessarily the present invention. Various techniques and mechanisms of the invention are sometimes described in singular form for clarity, but it will be understood that some embodiments include multiple iterations of a technique or multiple instances of a mechanism unless noted otherwise. Similarly, various steps of methods disclosed herein need not be performed in the particular order shown, or performed at all, in certain embodiments.

Definitions and Terminology. As used herein, the term “support card” (or “pipette tip support card”) refers to a generally planar member having a top surface with an array of pipette tip support holes configured to retain pipette tips in a vertical orientation, and a bottom surface (underside) opposite the top surface. The term “support structure” refers broadly to any structure extending from the support card in the same direction as the pipette tips to elevate the support card above a work surface; the support structure may be configured as a continuous apron wall or skirt, as a plurality of discrete pillars, posts, or legs, or as any other elevating geometry, including constructions formed from paper or cardboard. The term “receiver slot” refers to a recess, pocket, or opening formed in the bottom surface of a support card and dimensioned to receive a distal end of a pipette tip from an opposing support card with lateral clearance. The term “interleaved support card bundle” (or simply “bundle”) refers to an assembly of at least two support cards oriented with top surfaces facing outwardly and pipette tips extending inwardly to interleave without contact. The term “multi-channel pipettor” (also sometimes referred to as a “multiport pipetter”) denotes a pipetting device having multiple channels or ports configured to aspirate and dispense liquid using multiple pipette tips simultaneously. The term “plumb orientation” means a true vertical alignment in which the longitudinal axis of the pipette tip is perpendicular to the top surface of the support card within acceptable manufacturing tolerances (typically within 1-2 degrees of true vertical).

Parts List and Reference Numerals. For ease of reference, the following table summarizes example features and corresponding reference numerals used throughout the specification and drawings:

| | Reference |
|---|---|
| Feature Description | Numeral(s) |
| Interleaved support card bundle (two cards) | 5-1 |
| Interleaved support card bundle (four cards) | 5-2 |
| Interleaved support card bundle (six cards) | 5-3 |
| First support card | 10-1 |
| Second support card | 10-2 |
| Third support card | 10-3 |
| Fourth support card | 10-4 |
| Fifth support card | 10-5 |
| Sixth support card | 10-6 |
| First apron/support structure | 12-1 |
| Second apron/support structure | 12-2 |
| First lid | 15-1 |
| Second lid | 15-2 |
| Fourth lid (example) | 15-4 |
| Support card long edge | 16-1 |
| Support card short edge | 16-2 |
| Lid sliding direction (long edge) | 17-1 |
| Lid sliding direction (short edge) | 17-2 |
| First support structure distal edge | 18-1 |
| Second support structure distal edge | 18-2 |
| Support structure contact/abutment area | 19 |
| First top surface | 20-1 |
| Second top surface | 20-2 |
| First plurality of pipette tip support holes | 25-1 |
| Second plurality of pipette tip support holes | 25-2 |
| Third plurality of pipette tip support holes (example) | |
| First plurality of cutouts/partial holes | 35-1 |
| Multi-channel pipettor | 40 |
| Unobstructed region for pipettor access | 45 |
| First plurality of pipette tips | 50-1 |
| Second plurality of pipette tips | 50-2 |
| Pipette tips interleaved region | 55 |
| Long-side offset between hole arrays | 60-1 |
| Short-side offset between hole arrays | 60-2 |
| Receiver slot (first card underside) | 65-1 |
| Receiver slot (second card underside) | 65-2 |
| Cross-sectional view location on card | 10-2 (example) |

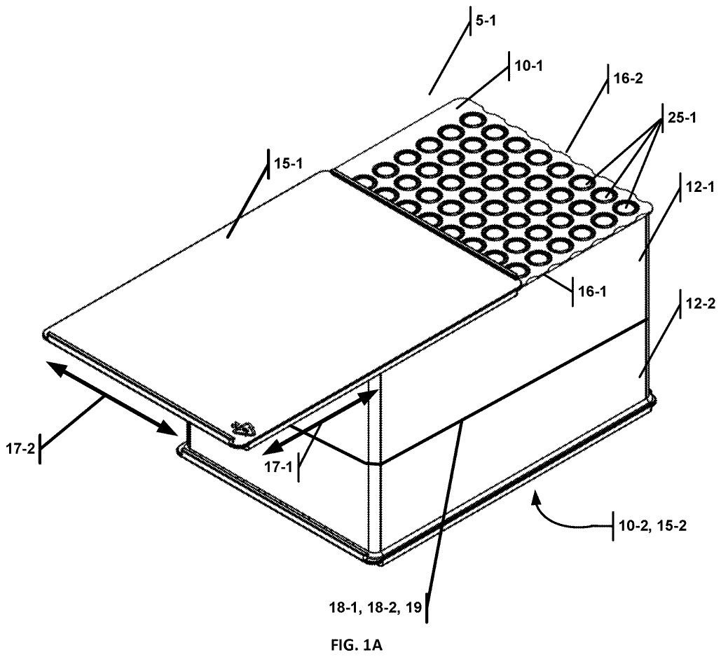

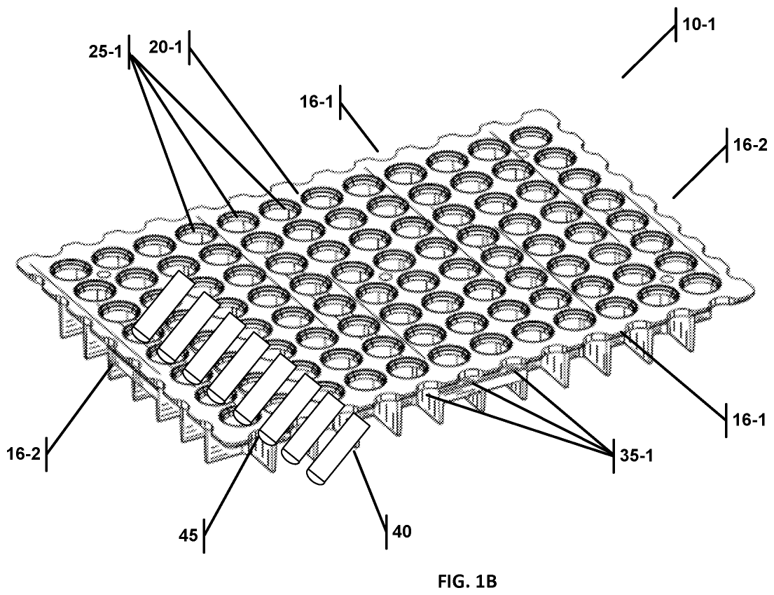

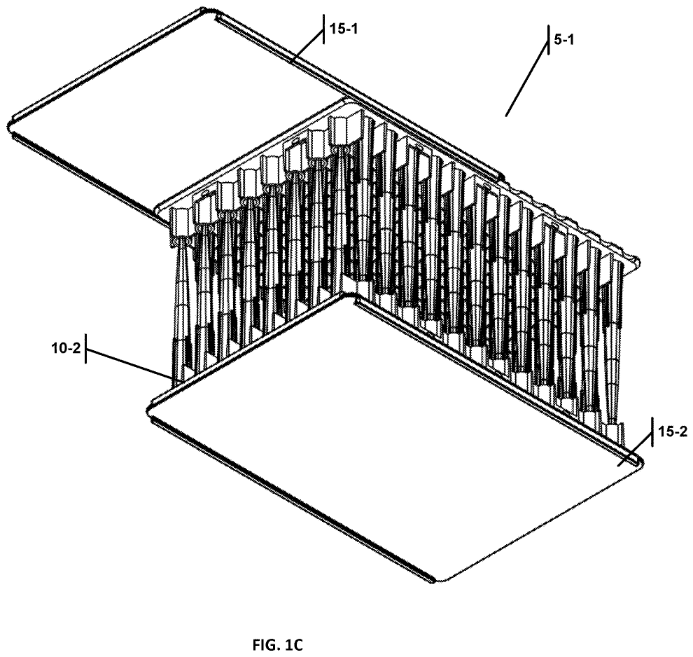

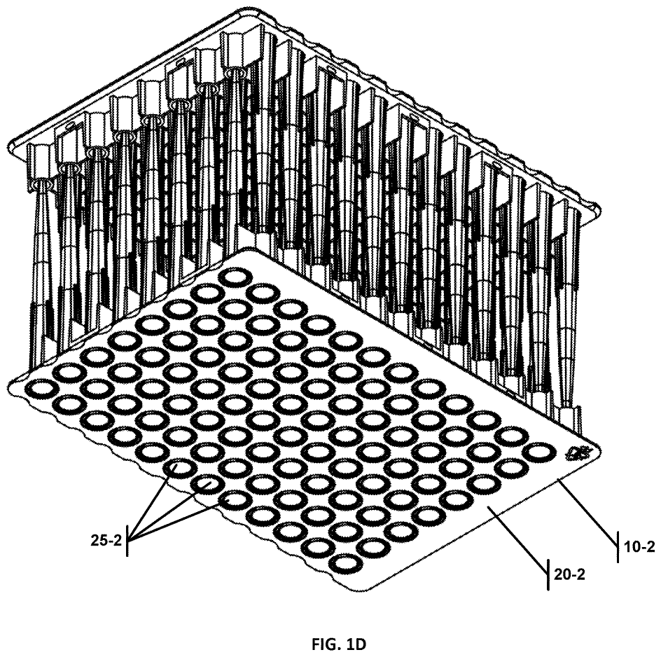

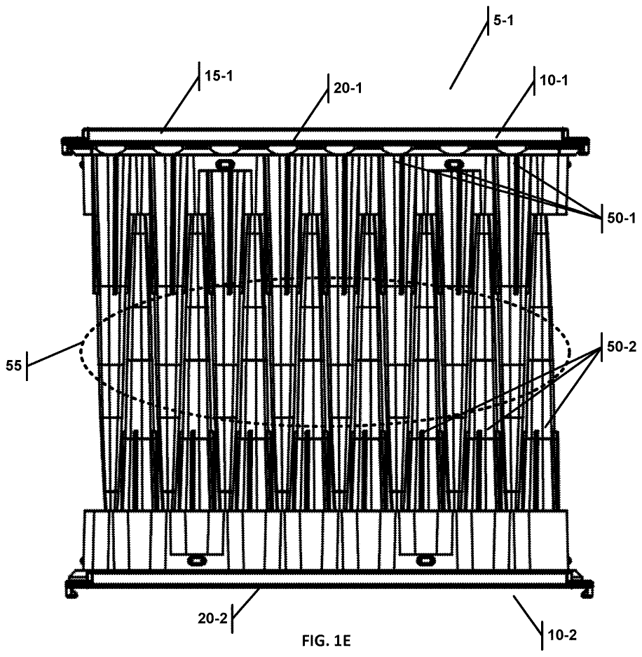

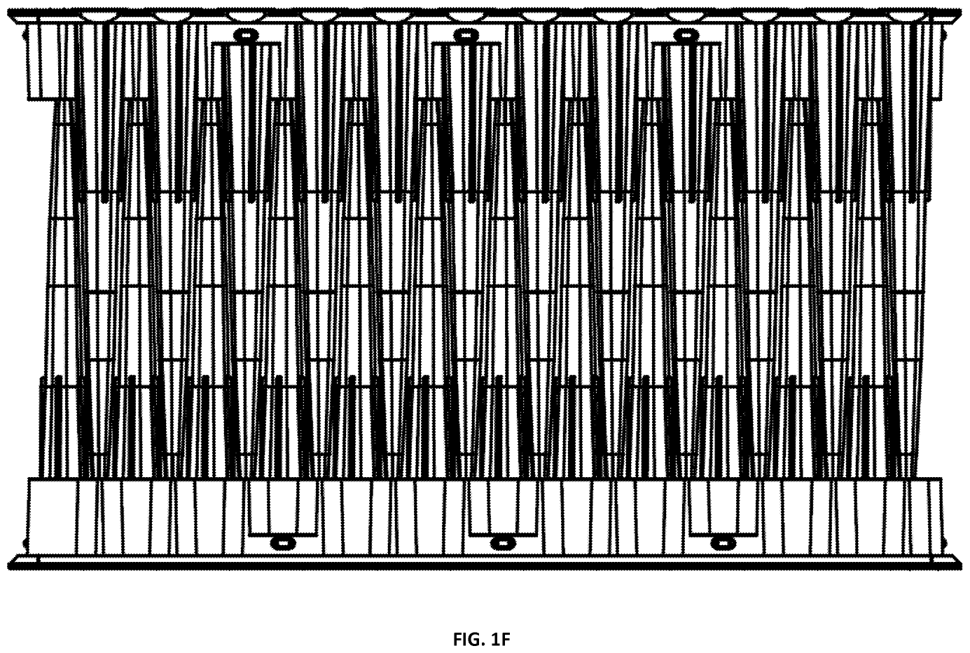

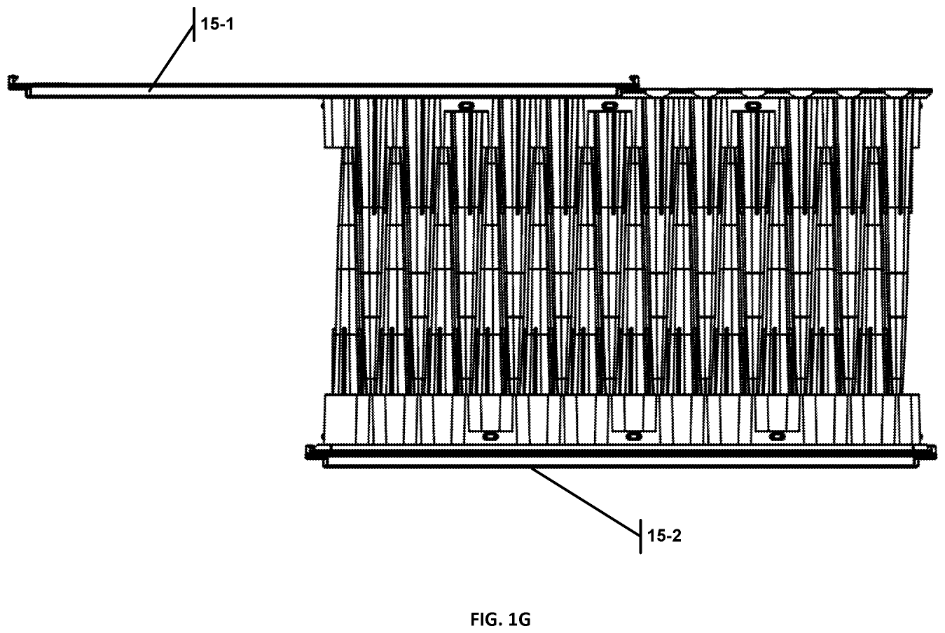

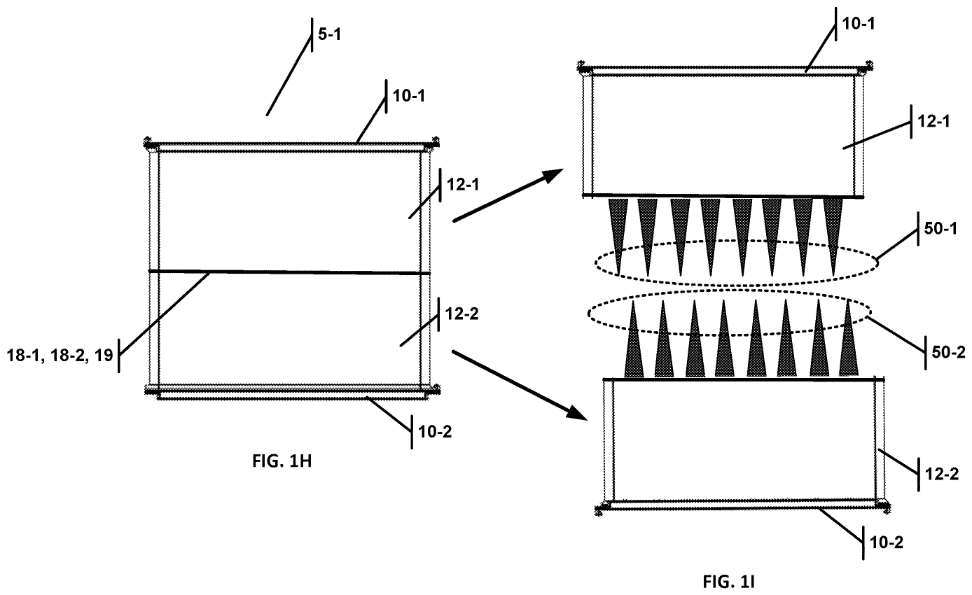

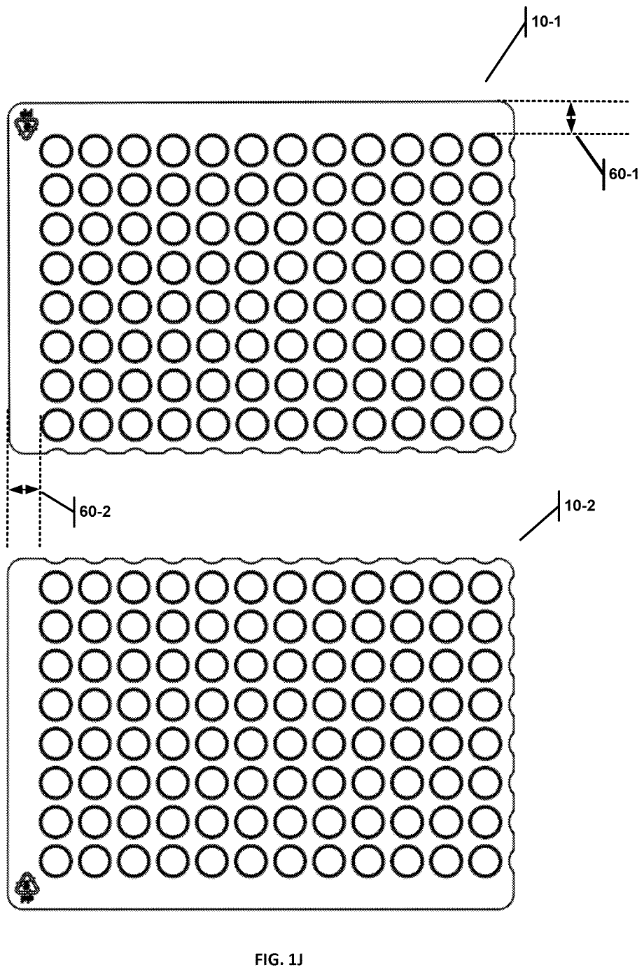

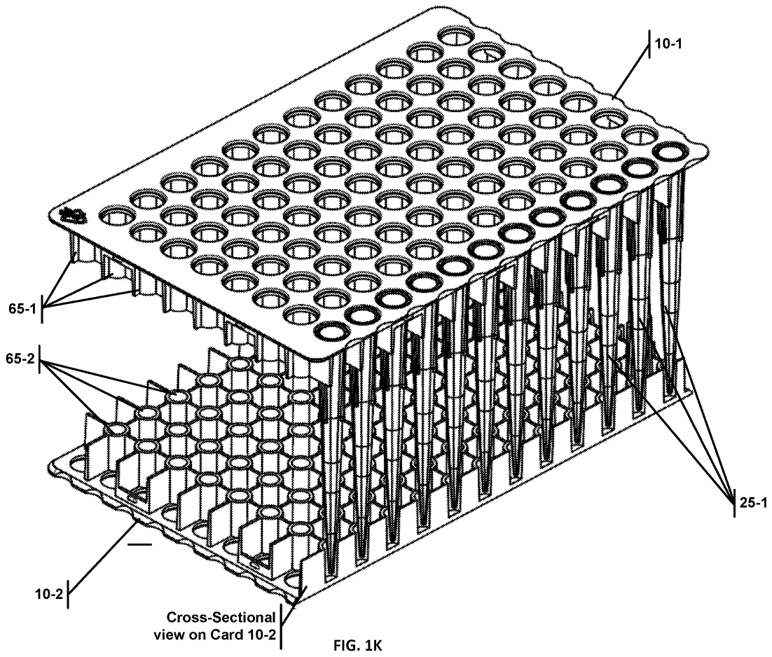

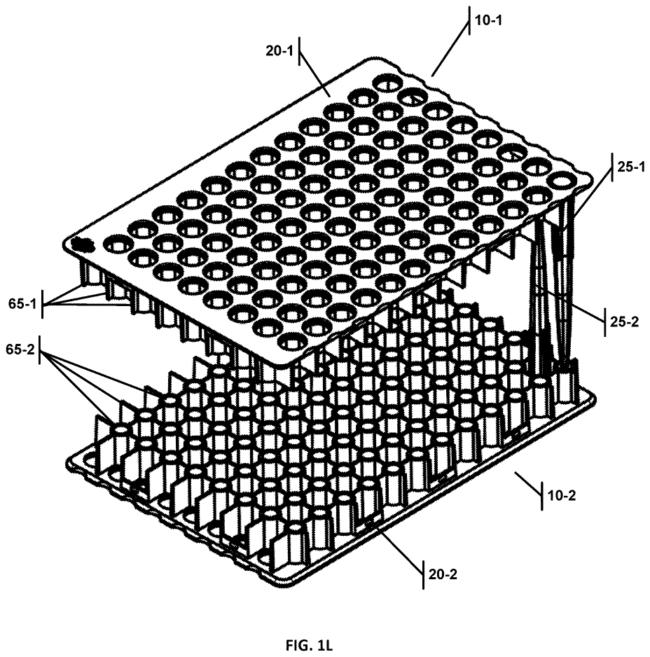

Turning now to FIGS. 1A-1L, an interleaved support card bundle 5-1 is shown comprising two pipette tip support cards 10-1 and 10-2. Each support card can be removed from the bundle 5-1 to access the pipette tips carried by that card, or the bundle may be used as an integrated unit by rotating it to present the desired card in an accessible orientation.

The first support card 10-1 includes a first top surface 20-1 that contains a first plurality of pipette tip support holes 25-1 arranged in an array (for example, an 8×12 array for 96 tips, or other standard or custom densities). A first plurality of pipette tips 50-1 is disposed in the support holes 25-1, and the pipette tips 50-1 extend away from the first top surface 20-1 in a first direction (see, for example, FIG. 1E). Similarly, the second support card 10-2 includes a second top surface 20-2 containing a second plurality of pipette tip support holes 25-2 arranged in an array. A second plurality of pipette tips 50-2 is disposed in the support holes 25-2, and the pipette tips 50-2 extend away from the second top surface 20-2 in a second direction opposite the first direction.

As illustrated in FIG. 1E, the first top surface 20-1 is substantially parallel to the second top surface 20-2 when the cards are assembled as the bundle 5-1. The first plurality of pipette tips 50-1 extends toward the second top surface 20-2, and the second plurality of pipette tips 50-2 extends toward the first top surface 20-1. The pipette tips 50-1 and 50-2 interleave with one another in an interleaved region 55 without tip-to-tip contact. The absence of tip-to-tip contact, combined with the lateral constraint provided by the receiver slots (described below), substantially eliminates the conditions that generate static electricity during shipping and handling and preserves the centered alignment of each tip within its support hole.

FIG. 1H illustrates a first support structure (shown as apron 12-1) connected to the first support card 10-1 and extending away from the first top surface 20-1 in the same direction as the first plurality of pipette tips 50-1. A second support structure (apron 12-2) is connected to the second support card 10-2 and extends away from the second top surface 20-2 in the same direction as the second plurality of pipette tips 50-2. The first support structure terminates in a first distal edge 18-1, and the second support structure terminates in a second distal edge 18-2. When the bundle 5-1 is assembled, the first and second distal edges 18-1, 18-2 abut one another at a contact area 19, thereby defining the spacing between the top surfaces 20-1 and 20-2 and structurally uniting the two cards into a single, manipulable bundle. The abutting contact provides sufficient frictional or mechanical stability for normal handling; for more rigorous shipping conditions, the bundle may be further secured by an optional outer wrap, band, or container.

The distance that the first support structure 12-1 extends from the first top surface 20-1 is less than the extension length of the first plurality of pipette tips 50-1 such that the tips 50-1 extend beyond the first distal edge 18-1 and into the receiver slots of the opposing card. The second support structure 12-2 has a corresponding construction relative to the second plurality of pipette tips 50-2 and the second distal edge 18-2 (see FIG. 1I). The support structures thus support the cards when the bundle 5-1 rests on a flat surface while allowing maximum interleaving of the pipette tips. In alternative embodiments, the support structure comprises a plurality of discrete pillars rather than (or in addition to) a continuous apron wall. Preferably, at least four pillars are provided, with one pillar positioned at or adjacent to each corner of the support card. This pillar configuration reduces material consumption and weight while still furnishing stable, level elevation of the support card. The pillars may be integrally formed with the support card (for example, by injection molding) or separately attached by adhesive, ultrasonic welding, snap-fit features, or other suitable means. In still other embodiments, the support structure—whether configured as an apron, as pillars, or as any other elevating geometry—is formed from paper or cardboard. Paper and cardboard constructions provide substantial cost and environmental advantages: they are inexpensive, recyclable, biodegradable, or compostable, and reduce the overall plastic content of the packaged product. When formed of paper or cardboard, the support structure is given sufficient thickness, fluting, corrugation, or reinforcement (for example, by folding into channels or L-sections, laminating, or coating) to impart the necessary rigidity and load-bearing capacity to support the weight of a fully loaded support card (typically 100-500 grams depending on tip size and count) during normal use, stacking, and shipping without excessive deflection.

In some embodiments, each support card includes a lid. For example, the first support card 10-1 may include a first lid 15-1 configured to cover the first top surface 20-1 and retain the first plurality of pipette tips 50-1 in the support holes 25-1. The first lid 15-1 may be a sliding lid configured to translate along a long edge 16-1 or a short edge 16-2 in a corresponding lid sliding direction 17-1 or 17-2, as illustrated in FIG. 1A. In other embodiments, the lid may be snap-fit or hinged. The second support card 10-2 may include a second lid 15-2 with a similar construction (see FIGS. 1A and 1C). The lids protect tips from contamination and prevent dislodgement during handling; they may be opened individually or left closed on non-accessed cards when the bundle is rotated to present a particular card for use.

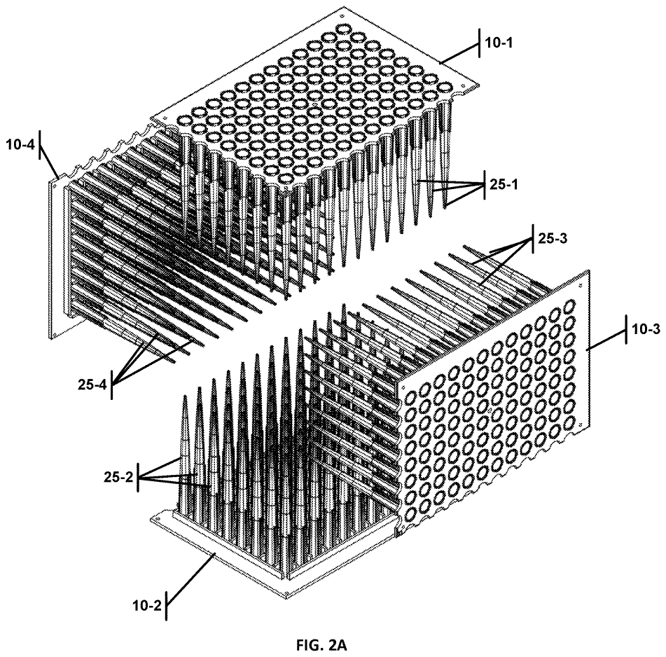

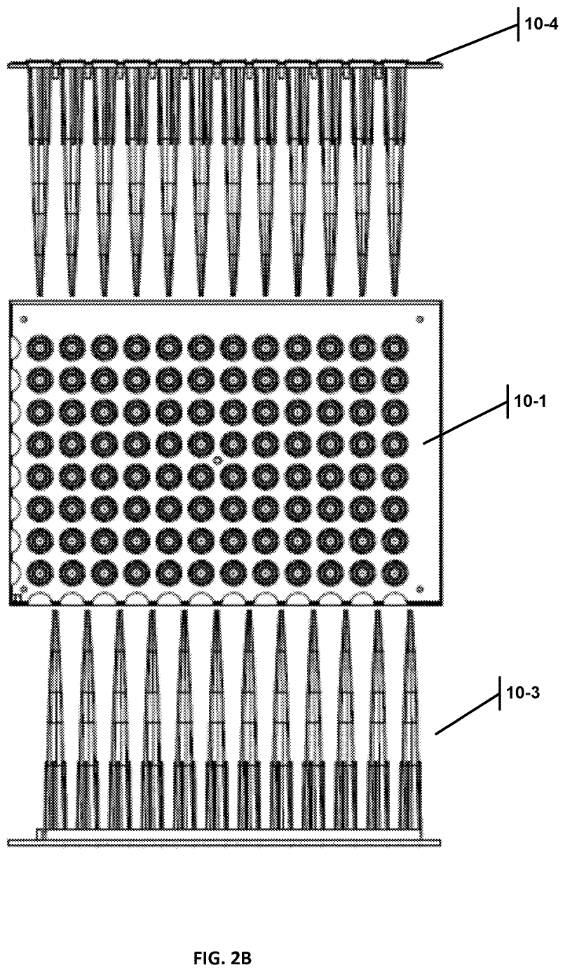

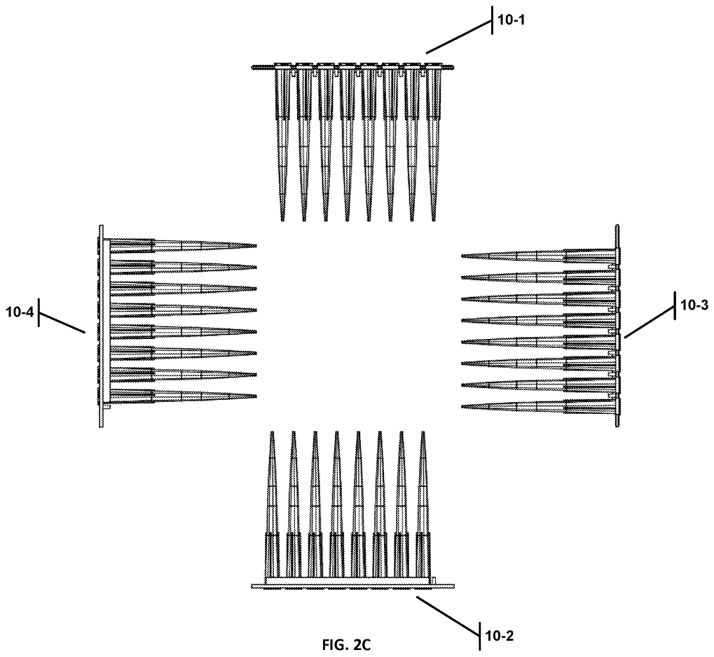

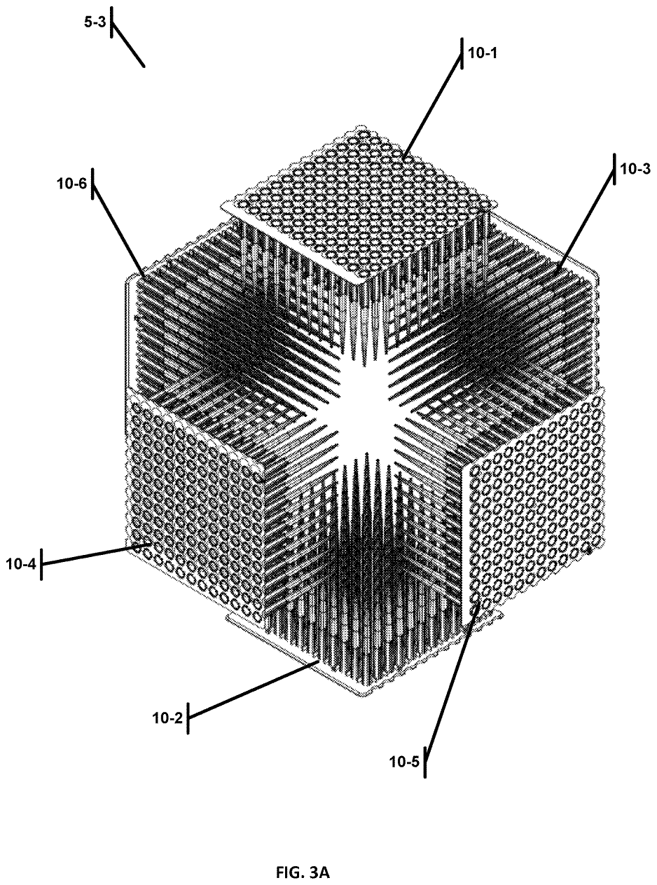

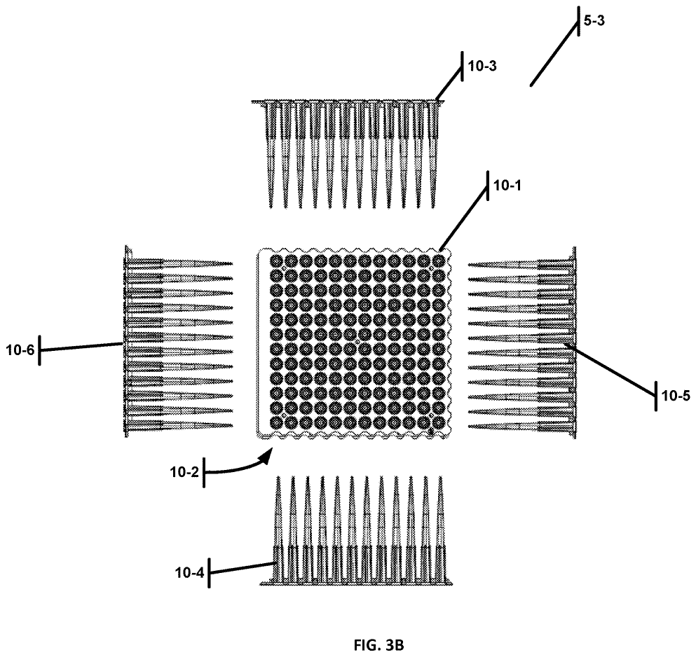

The bundle 5-1 may be used as follows. The bundle is initially positioned such that the first top surface 20-1 is generally horizontal and facing upward. The first lid 15-1 is opened (or removed) to expose the first plurality of pipette tips 50-1, and a pipettor—such as a handheld single-channel or multi-channel pipettor, an automated liquid handler, or a pump-based aspiration device—aspirates one or more of the pipette tips 50-1. If desired, the second lid 15-2 may remain closed during this operation to prevent pipette tips 50-2 from dislodging from the second support card 10-2. After at least some of the first plurality of pipette tips 50-1 have been used, the first lid 15-1 may be closed to protect any remaining tips 50-1. The bundle 5-1 is then rotated approximately 180° so that the second top surface 20-2 faces upward, the second lid 15-2 is opened, and at least some of the second plurality of pipette tips 50-2 are aspirated. When the bundle includes additional interleaved pairs (for example in bundles of four or six support cards as shown in FIGS. 2A-3B), the user can repeat this process, rotating the bundle in 90° increments to access additional cards while keeping non-accessed cards closed to secure their tips. This rotational access pattern provides ergonomic and contamination-control benefits in both manual and automated workflows.

FIG. 1B illustrates the first support card 10-1 removed from the bundle 5-1. A first plurality of peripheral partial holes or cutouts 35-1 is formed along at least one edge, such as the long edge 16-1. In the illustrated embodiment, cutouts 35-1 are provided along all four edges of the support card 10-1. The cutouts 35-1 define an unobstructed region 45 that permits a multi-channel pipettor 40 to access a subset of tips in a row without interference from the card edge. By way of example, if a multi-channel pipettor 40 is configured to aspirate eight tips but only five tips in a row are to be accessed, three of the pipettor channels must pass along the edge of the support card 10-1. Without the cutouts 35-1, the edge of the card would obstruct movement of those unused channels. The cutouts 35-1 create the unobstructed region 45 so that the multi-channel pipettor 40 can move into position and access the desired subset of pipette tips without collision. The second support card 10-2 may include a similar plurality of cutouts.

As shown in FIG. 1J, the first support card 10-1 may be formed with a long-side offset 60-1 and a short-side offset 60-2 relative to the second support card 10-2. The second support card 10-2 has a corresponding but mirror-image construction. The longitudinal and lateral offsets 60-1, 60-2 assist in staggering the pipette tips of opposing support cards so that they can interleave without interference. The specific magnitude of the offsets is selected based on the pitch of the hole array and the geometry of the pipette tips so that each tip of one card aligns coaxially with a receiver slot of the opposing card. For a standard 96-well array having a 9 mm center-to-center pitch, the long-side and short-side offsets are typically on the order of 4.5 mm (half-pitch) or another value that maps tips to slots without overlap or collision; the exact value can be readily determined by a person of ordinary skill in the art for any given array density and tip profile.

FIG. 1K illustrates underside receiver slots 65-1 formed in the bottom surface of the first support card 10-1. Each receiver slot 65-1 is coaxially aligned with a corresponding pipette tip support hole 25-1 on the first support card 10-1 and is configured to receive the distal end of a pipette tip from the opposing support card 10-2. FIG. 1K also illustrates receiver slots 65-2 formed in the second support card 10-2, shown in cross-section. FIG. 1L illustrates distal ends of pipette tips from opposing support cards disposed in the underside receiver slots 65-1, 65-2. The receiver slots 65-1, 65-2 are dimensioned so that the distal ends of the opposing pipette tips are received with clearance (typically 0.2-1.0 mm diametral or lateral clearance, depending on tip distal outer diameter and manufacturing tolerances) and do not contact the opposing card or bind against the slot walls in a manner that would impede subsequent removal or generate particles. The combination of interleaving, tip staggering via offsets, and receiver slots substantially prevents tip-to-tip and tip-to-card contact during shipping and handling, reducing static buildup and maintaining the pipette tips in a centered position within their support holes. This is particularly advantageous for automated pipetting systems that rely on precise alignment between the pipettor channels and the support hole array to ensure reliable tip pickup, consistent sealing, and accurate dispensing.

In addition, because the distal ends of the pipette tips from one card are enclosed within the receiver slots of the opposing card and do not contact the opposing support card or other pipette tips, the receiver slots substantially prevent cross-contamination between the first plurality of pipette tips and the second plurality of pipette tips. Any residue, liquid, or particulate matter present on one set of tips cannot transfer to the opposing tips or card surface during shipping, handling, or storage.

Manufacturing and Curing Advantage. The receiver slots on the underside of the support card serve an additional, important manufacturing function that was not previously appreciated in the art. Pipette tips are commonly produced by injection molding or similar forming processes using thermoplastic materials such as polypropylene. Immediately after formation (ejection from the mold), the tips are often still warm (typically 40-80° C. or higher depending on material and cycle), dimensionally unstable, or not fully cured, crystallized, or set. If such tips are allowed to rest on a flat surface or in a conventional rack without lateral constraint at the distal end, the distal ends can drift laterally under gravity or residual internal stresses, causing the tips to cure in a bent or out-of-plumb condition. Correcting such defects later requires additional labor, dedicated curing fixtures, manual straightening, or scrapping of out-of-specification parts—all of which increase cost and cycle time.

With the present support card, a newly formed pipette tip can be inserted directly into a support hole while the tip is still in a formable or uncured state. The distal end of the tip is guided into and captured by the corresponding receiver slot on the underside of the card. The receiver slot wall surrounds and laterally constrains the distal end (while providing sufficient clearance for easy subsequent removal), thereby automatically aligning and holding the tip in a plumb (vertical) orientation. The tip is suspended by the support hole at its proximal end and stabilized at its distal end by the receiver slot. As the tip cools and cures, it retains this plumb geometry. No separate curing fixture or manual intervention is required. Because the loaded support card maintains all tips in the correct plumb orientation, the entire assembly can be packaged and shipped before the pipette tips have reached full cure. Curing or drying continues during transportation. This capability shortens the manufacturing cycle, lowers work-in-process inventory, reduces the time from molding to customer delivery, and improves overall production efficiency and product consistency. The same receiver-slot feature that prevents tip-to-tip contact and static buildup during shipping therefore also serves as a built-in curing and alignment fixture during manufacture, providing a synergistic benefit that enhances both the commercial product and the manufacturing process that produces it.

To further enable a person of ordinary skill in the art to make and use the invention without undue experimentation, the following guidance is provided. The receiver slots are preferably formed with a depth sufficient to capture at least 2-5 mm (or more, depending on tip length and distal taper) of the distal end without the tip bottoming out against the slot floor or the proximal seating of the tip in the support hole being affected. The lateral clearance between the receiver slot wall and the distal outer surface of the tip is typically in the range of 0.2-1.0 mm, sufficient to avoid binding or particle generation yet close enough to provide meaningful lateral constraint during handling and cure. The support cards are typically injection molded from polypropylene, polystyrene, or similar polymers, optionally compounded with anti-static additives (e.g., carbon black, conductive fibers, or migratory antistatic agents) to achieve surface resistivity in the range of 10⁹-10¹² ohms/square. For paper or cardboard support structures, corrugated board of 200-400 lb test strength, folded or formed into legs or channels of appropriate height, and attached to the card underside at corner regions by biodegradable adhesive, interlocking tabs, or staples, provides adequate rigidity while meeting environmental objectives. The longitudinal and lateral offsets between opposing hole arrays are selected so that each tip axis of one card is substantially coaxial with a receiver slot axis of the opposing card; for standard arrays this is readily achieved by offsetting by approximately one-half the center-to-center pitch or by other values determined by simple geometric mapping. These parameters are provided as examples; a person of ordinary skill in the art can optimize them for any particular tip geometry, array density, and material system using routine experimentation guided by the principles disclosed herein.

FIGS. 2A-2C illustrate an interleaved support card bundle 5-2 comprising four pipette tip support cards 10-1, 10-2, 10-3, and 10-4. The third support card 10-3 and fourth support card 10-4 may have constructions similar to that of the first support card 10-1 described above. In the illustrated embodiment, the third support card 10-3 and the fourth support card 10-4 form a second interleaved pair in which the top surface of the third support card 10-3 is substantially parallel to the top surface of the fourth support card 10-4. Pipette tips carried by the third support card 10-3 extend toward the top surface of the fourth support card 10-4, and pipette tips carried by the fourth support card 10-4 extend toward the top surface of the third support card 10-3, interleaving without contact as described for the first pair. The pair of support cards 10-3 and 10-4 is oriented substantially orthogonally to the pair of support cards 10-1 and 10-2, for example rotated by about 90° about a central axis of the bundle 5-2. This arrangement allows four fully loaded support cards to be packed into a compact, generally cubic bundle that is only slightly taller than one conventional support card plus one tip length. A user can access pipette tips from any card by rotating the bundle 5-2 to bring the desired top surface into an upward-facing, accessible orientation and opening the corresponding lid, if present. Non-accessed cards remain protected.

FIGS. 3A and 3B illustrate an interleaved support card bundle 5-3 comprising six pipette tip support cards 10-1, 10-2, 10-3, 10-4, 10-5, and 10-6. The fifth support card 10-5 and sixth support card 10-6 may again have constructions similar to that of the first support card 10-1. In this embodiment, the fifth support card 10-5 and the sixth support card 10-6 form a third interleaved pair in which the top surface of the fifth support card 10-5 is substantially parallel to the top surface of the sixth support card 10-6. Pipette tips supported by the fifth support card 10-5 extend toward the top surface of the sixth support card 10-6, and pipette tips supported by the sixth support card 10-6 extend toward the top surface of the fifth support card 10-5, interleaving without contact as described above. The three interleaved pairs (10-1/10-2, 10-3/10-4, and 10-5/10-6) are oriented substantially orthogonally to one another to form a compact multi-pair bundle 5-3. As with the four-card bundle 5-2, the bundle 5-3 can be rotated in 90° increments to sequentially access the pipette tips carried by each support card while keeping non-accessed cards closed to protect their tips. The orthogonal multi-pair arrangement maximizes packing density while preserving individual card accessibility and protection.

The foregoing description of embodiments is provided to enable any person skilled in the art to make and use the invention. Various modifications to these embodiments will be readily apparent to those skilled in the art, and the generic principles described herein can be applied to other embodiments without departing from the spirit or scope of the invention. Accordingly, the described and illustrated embodiments are to be considered representative and not limiting. The scope of the invention is defined solely by the appended claims.

1-8. (canceled)

9. An interleaved support card bundle comprising:
a first support card comprising a first top surface containing a first plurality of pipette tip support holes arranged in a first array, a first plurality of pipette tips seated in the first plurality of pipette tip support holes and extending away from the first top surface in a first direction, a plurality of receiver slots formed in an underside of the first support card opposite the first top surface, each receiver slot having a receiver slot wall, and a first support structure extending from the first support card in the first direction a distance less than an extension length of the first plurality of pipette tips;
a second support card comprising a second top surface substantially parallel to the first top surface and containing a second plurality of pipette tip support holes arranged in a second array that is offset relative to the first array, a second plurality of pipette tips seated in the second plurality of pipette tip support holes and extending away from the second top surface in a second direction opposite the first direction, and a second support structure extending from the second support card in the second direction a distance less than an extension length of the second plurality of pipette tips;
wherein the first plurality of pipette tips and the second plurality of pipette tips interleave with one another in a region between the first top surface and the second top surface without contacting one another;
wherein distal ends of the second plurality of pipette tips are received in the plurality of receiver slots with clearance such that the receiver slot walls laterally constrain the distal ends without the distal ends contacting the first support card or binding against the receiver slot walls, thereby preventing contact between the first and second pluralities of pipette tips and maintaining alignment of the pipette tips within their respective support holes during shipping and handling; and
wherein a distal edge of the first support structure abuts a distal edge of the second support structure, thereby defining a spacing between the first and second top surfaces and structurally connecting the first and second support cards as the interleaved support card bundle.

10. The interleaved support card bundle of claim 9, wherein at least one of the first support structure or the second support structure comprises a plurality of pillars.

11. The interleaved support card bundle of claim 10, wherein the plurality of pillars comprises at least four pillars, with at least one pillar positioned at or adjacent to each corner of the respective support card.

12. The interleaved support card bundle of claim 9, wherein at least one of the first support structure or the second support structure comprises paper or cardboard having sufficient rigidity to support the weight of a fully loaded support card during handling, stacking, and shipping.

13. The interleaved support card bundle of claim 13, further comprising a lid configured to cover at least one of the first top surface or the second top surface and retain the respective plurality of pipette tips in the support holes.

14. The interleaved support card bundle of claim 5, wherein the lid is a sliding lid translatable along an edge of the support card, and wherein the support card comprises a plurality of peripheral cutouts defining an unobstructed region permitting a multi-channel pipettor to access a subset of pipette tips without interference from the support card edge.

15. The interleaved support card bundle of claim 9, further comprising a third support card and a fourth support card forming a second interleaved pair oriented substantially orthogonally to the first and second support cards, wherein pipette tips of the third and fourth support cards interleave without contact and distal ends thereof are received in receiver slots of the opposing card of the second pair, and wherein distal edges of support structures of the third and fourth support cards abut to define spacing and unite the second pair.

16. The interleaved support card bundle of claim 15, further comprising a fifth support card and a sixth support card forming a third interleaved pair oriented substantially orthogonally to both the first pair and the second pair, thereby forming a six-card bundle having a generally cubic footprint.

17. The interleaved support card bundle of claim 9, wherein at least one of the first support card or the second support card is formed from an anti-static or static-dissipative polymer composition.

18. The interleaved support card bundle of claim 9, wherein the receiver slots substantially prevent cross-contamination between the first plurality of pipette tips and the second plurality of pipette tips by enclosing the distal ends of the pipette tips and preventing contact between the pipette tips and the opposing support card.

19. A method of manufacturing pipette tips, the method comprising:
forming a plurality of pipette tips by a molding or forming process;
providing a support card having a top surface with a plurality of pipette tip support holes extending therethrough and an underside with a plurality of receiver slots, each receiver slot being substantially coaxially aligned with a corresponding support hole;
while the formed pipette tips remain in a formable or uncured state, inserting each pipette tip into a respective support hole such that a distal end of the pipette tip enters the corresponding receiver slot and is laterally constrained by a wall of the receiver slot, thereby maintaining the pipette tip in a plumb orientation relative to the top surface; and
permitting the pipette tips to cure or set while held in the plumb orientation by the support card and receiver slots.

20. The method of claim 19, further comprising packaging the support card loaded with the inserted pipette tips for shipment prior to completion of curing, wherein curing of the pipette tips continues during transit.

21. The method of claim 19, wherein the support card is part of an interleaved support card bundle according to claim 1, and wherein the method further comprises assembling at least a second support card into the bundle such that pipette tips of the second support card are received in receiver slots of the first support card with clearance.
